(19) United States
(12) Patent Application Publication
(10) Pub. No.: US 2013/0311270 A1
(43) Pub. Date: Nov. 21, 2013

(54) MOOD-BASED SEARCHING AND/OR ADVERTISING SYSTEMS, APPARATUS AND METHODS

(71) Applicant: TURNED LIVE, INC., Austin, TX (US)

(72) Inventors: Nikhil Daftary, Austin, TX (US); Zelal Gungordu, Vienna, VA (US)

(73) Assignee: TURNED LIVE, INC., AUSTIN, TX (US)

(21) Appl. No.: 13/896,741

(22) Filed: May 17, 2013

Related U.S. Application Data
(60) Provisional application No. 61/648,457, filed on May 17, 2012.

(51) Int. Cl. G06Q 30/02

(52) U.S. Cl. CPC G06Q 30/0269
USPC 705/14.43; 705/14.58; 705/14.66

(57) ABSTRACT

Apparatus, methods, etc. for mood-based searching and/or advertising. Some methods comprise receiving a mood-based search request including the requestor's mood. The requestor mood is limited to a predetermined mood set. A database is searched for activities subjectively suitable for the requestor mood. Such methods also comprise outputting the suitable activities. Some methods comprise receiving feedback regarding the activity ambience. If desired, some methods comprise adjusting an initial activity ambience responsive thereto. Moreover, some methods comprise adjusting variables used to derive the initial ambience markings. Furthermore methods comprise targeting advertising based on a path associated with the activities. Furthermore, some methods comprise limiting the targeted advertising to activities suitable for the requestor mood (which can comprise multiple moods and/or a mood recipe). The activities can be initially marked with moods determined from web-scraped content and semantically analyzing the same.

### CROSS-REFERENCE TO RELATED APPLICATIONS

This application claims priority to Provisional U.S. Patent Application Ser. No. 61/648,457 entitled “Mood-Based Search and Advertising,” filed by Nikhil Daftary on May 17, 2012, the entirety of which is incorporated herein as if set forth in full.

### BACKGROUND

As the amount of information available via the Internet increases, it is becoming increasingly difficult to locate information that is of interest. Thus, the ability to efficiently search the Internet for information of interest can be valuable. Many Internet searches are performed via keyword-based search engines. These search engines typically build a database representing Internet-accessible information (web pages et al.), search the database based on a textual search query entered by a user, and return search results that include words matching the textual search query.

Search engines can be general (e.g., Internet-wide) or can be specifically tailored to particular types of information (for instance, a search engine for a local newspaper's website tailored to search for articles and classified advertisements published by the newspaper). When a user knows that his or her desired search results are likely to fit into a particular category of information, a tailored search engine may be more useful than a general search engine if one is available and known to the user. For example, when a user is looking for local concerts in the next month, a local activity search engine may produce more relevant results than a general search engine. However, given the subjective nature of musical tastes (and tastes related to other activities), searching based on available genre-related terms such as “rock” and “blues” may not be sufficient. Moreover, a user may not be able to “put into words” the type of activity he or she is looking for and may not even be able to identify a type of search engine that has any reasonable chance of returning meaningful results.

### SUMMARY

The following presents a simplified summary in order to provide a basic understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, methods, etc. for searching and/or advertising on wide area networks for activities of interest and more particularly for Internet searching and advertising related to entertainment activities.

In accordance with embodiments, mood-based searching and/or advertising systems, methods, etc. are provided which reflect how users often think of activities in which they wish to participate. Systems of the current embodiment collect from the users certain information in order to perform mood-based searching and/or advertising. The collected information includes the desires of the users to participate in some activity (colloquially, they want to “go out), their willingness to spend money to do so, and the reason(s) that they want to participate in some activity. On the latter point, many times the reason that they want to participate in some such activity is that they are in a particular mood to do so. Moreover, due to the nature of the mood-based searches it is often the case that these users want to participate in the activity in the near-term (colloquially, “right now) although that is not always the case.

Systems of the current embodiment eliminate much noise from the search results that might otherwise be returned in keyword-based search systems heretofore available. Moreover, systems provided herein tend to return only results that these users want more frequently than heretofore-available systems. Furthermore, the activities which the users seek often tend to be impulse purchases involving relatively modest amounts of money. For instance, many activities sought after by the users cost about $50 or less although greater sums can be involved.

Furthermore, it is often the case that the user wishes to have to perform little or no planning for these sought after activities. For instance, the user might be looking for something to do that would involve as little planning as is desirable to arrive at a theater in time for a showing of a movie. However, activities associated with more planning such as going out for the evening are within the scope of the current disclosure and embodiments can help with such planning. Indeed, systems of the current embodiment can enable users to perform relatively quick, mood-based searches for an activity/activities for an evening, for longer/different time frames, and/or for what to do next. Such mood-based systems also help make finding an activity easy while also avoiding forcing users to describe how they feel and/or what their mood might be.

With regard to mood-based advertising, systems of the current embodiment can also benefit businesses which wish to advertise to such users. More specifically, since these systems can possess information related to the users' moods, their willingness to spend, their demographics, their purchasing preferences, etc., these systems can qualify potential customers in manners not heretofore possible. With the foregoing information the business owners (and/or others) can target advertising for these users which is likely to be pertinent to the users' mood and desire for the products, services, activities, etc. promoted by the targeted advertising.

Further still, in some embodiments, the system also qualifies these potential customers according to a path between the various activities returned by the mood-based searches involved. Such path-based advertising can be combined with psycho-graphic analysis (analysis related to the moods of the users) to place advertising with the users which the users are likely to be interested in receiving. Thus, instead of receiving a potential barrage of unwanted advertisements, the users will receive well-targeted advertising. The advertising they do receive, moreover, need not be aimed at helping the users discover new businesses, products, services, activities, etc. Rather, the advertisements can be welcome reminders of activities in which the users want to engage.

Methods in accordance with some embodiments comprise receiving, via a network, a mood-based search request which includes a self-indication of a mood of a requestor. In these methods the requestor mood is limited to a predetermined set of moods and a database (stored on a computer readable media which is not a signal) is searched for activities which have ambiences subjectively suitable for the requestor mood using a processor. Methods in accordance with the current embodiment also comprise outputting an indication of at least one activity which has an ambience which is subjectively suitable for the limited requestor mood via the network.

Methods in accordance with various embodiments can comprise receiving feedback from a user regarding the ambience of the activity. If desired, some methods comprise adjusting the initially marked ambience of the activity responsive to the feedback. In addition, or in the alternative, some methods comprise adjusting variables from which the initially marked ambience was derived responsive to the feedback.

In accordance with various embodiments, such methods can also comprise targeting advertising to the requestor based on a path between a location associated with the requestor and a location of one of the activities. Furthermore, these methods can comprise limiting the targeted advertising to advertising pertaining to activities which are defined in part by ambiences which are subjectively suitable for the limited requestor mood. For some methods the limited requestor mood further comprises multiple moods. In addition, or in the alternative, some methods comprise receiving an indication of a mood recipe, the limited requestor mood being the mood recipe. The activities in the database can be initially marked with activity ambiences determined from web scraping content regarding the activities and semantically analyzing the scraped content.

Some embodiments provide apparatus configured to perform such methods. For instance, embodiments provide apparatus comprising a network interface, a processor, and a memory storing processor readable instructions which when executed by the processor cause the processor to perform such methods. In various embodiments, the method comprises receiving, via the network interface, a mood-based search request which includes an indication of a mood of a requestor wherein the requestor mood is limited to a predetermined set of moods. The method of the current embodiment also comprises searching a database stored in the memory for activities subjectively suitable for the limited requestor mood using the processor. Moreover, the method of the current embodiment also comprises outputting an indication of at least one activity which has an ambience which is subjectively suitable for the requestor mood via the network interface.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other advantages and novel features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually corresponds to the figure in which the reference number first appears. The use of the same reference numbers in different figures usually indicates similar or identical items.

FIG. 1 illustrates an overview of a system for mood-based searching and/or advertising.

FIG. 2 illustrates a block diagram of a system for mood-based searching and/or advertising.

FIG. 3 illustrates a flowchart of a method associated with mood-based searching and/or advertising.

FIG. 4 illustrates another flowchart of a method associated with mood-based searching and/or advertising.

FIG. 5 illustrates yet another flowchart of a method associated with mood-based searching and/or advertising.

FIG. 6 illustrates a system for mood-based searching and/or advertising.

FIG. 7 illustrates a screenshot of a graphical user interface (GUI) associated with mood-based searching and/or advertising.

FIG. 8 illustrates a screenshot of another GUI associated with mood-based searching and/or advertising.

FIG. 9 illustrates yet another a screenshot of a GUI associated with mood-based searching and/or advertising.

FIG. 10 illustrates still another screenshot of a GUI associated with mood-based searching and/or advertising.

FIG. 11 illustrates a screenshot of search results associated with mood-based searching and/or advertising.

### DETAILED DESCRIPTION

This document discloses systems, apparatus, methods, etc. for searching and/or advertising on wide area networks for activities and more particularly for mood-based searching and advertising on the Internet and being related to entertainment activities.

Search engines of embodiments use subjective descriptions to identify activities that might be of interest to users. In part or in whole this is because describing activities with subjective descriptions may be more accurate and more useful than using objective descriptions despite the vagaries often associated with such subjective descriptions. For example, describing a concert by ambience (“energetic” and “intense” among others) may be more meaningful to a human user than merely describing it as a “rock” concert. In this case, a person may be more interested in the “vibe” or ambience of a particular event than the actual specific genre of the event.

Traditionally, genre has been used as a proxy to describe the vibe or ambience of an event. For instance, a mellow night of music can include soft jazz, ‘shoe-gaze pop,’ classical or folk-Americana. But, then again, a user might find that any particular band or concert within one of these genres would not have a mellow ambience. In part, that might be because the ambience of music across a given genre is typically inconsistent. Thus, some music within a genre generally perceived to be mellow (perhaps country music) will have ambiences other than mellow. Similarly, some music within a generally energetic genre (for instance rock music) will have ambiences other than energetic (perhaps mellow). Furthermore, a user who could search for a mellow night out would have more options available to them as compared to some one who merely searches for “classical live music” or some other specific set of keywords. Moreover, describing a restaurant as “mellow” and “sensual” may convey more meaning to that person than merely describing it as “steakhouse” or “fine dining.”

It might be worth noting that live events and restaurants may be broadly classified as activities or “things to do,” which may also include bars, movies, books, theatre, and outdoor activities. Each such activity may evoke an emotional response. Thus, when searching for activities that can evoke an emotional response, subjective or mood-based searches might return more relevant search results than objective genre-based or keyword-based searches. To illustrate, although two restaurants can be classified as “Italian,” a “quirky” and “sunny” Italian restaurant may be more appropriate for a date while a “mellow” Italian restaurant may be more appropriate for a business lunch. A user searching for one of these restaurants would likely be disappointed with the other restaurant.

Using moods to define a search may narrow information to that which is directly relevant to a user's state of mind at the time of the search. Moreover, when a user interacts with mood-based search results, the user validates his or her emotional state of being. For instance, a user that searches for actionable information related to mellow, energetic, or sensual activities is stating that they want to consume information that furthers that mood, whether that information is relevant right now or in the near or not so near future.

Because there may be an infinite number of possible words to describe any particular mood, mood-based searches can be confined to terms that have been determined (based on academic analysis, user surveys, etc.) to be fairly mutually exclusive. In accordance with embodiments, mood-based searches may be confined to 7 of 8 moods: Sunny, Sensual, Mellow, Melancholy, Energetic, Intense and Quirky. The 8th (excluded) mood of the current embodiment is bitterness/hatred. It might be worth noting that combinations of these 8 moods cover the vast majority of mood mixes which humans experience. The search mechanism and content flow can begin with the users picking or combining some of the above 7 (or 8) moods to define what they are “in the mood to do.” By selecting from among the aforementioned 7 mutually exclusive words to describe specific moods/feelings, confusion or overlap between the singular moods may be avoided. Each activity or event (hereinafter “activity”) loaded into the system may be automatically categorized by ambience based on specific metrics. Once evaluated, the search engine of the current embodiment assigns each activity points across the 7 ambiences (corresponding to the moods) which sum to 100% of the possible points.

The number of points assigned to each ambience for an activity may be automatically determined based on various factors. For example, a dining destination's initial ambience mix may be based at least in part on cuisine, dining style, price, and preferred attire. Note that an ambience mix can change over time. Accordingly, users can rank venues, performers, and activities by ambience each time they participate in that activity. For instance, restaurant A may be mellow during the day and energetic by night. Moreover, ambiences may change by day. Restaurant A may be mellow Sunday through Thursday and energetic on Friday and Saturday. Thus, user feedback can be used to keep activity ambience mixes current and relevant to the various mood-based searches the system processes. By taking into account the time of day and the date of ambience-feedback for a venue, ambiences can dynamically adjust to circumstances to optimize the particular time that a user might want to attend or experience a particular activity. In addition to user-driven feedback, venue owners and/or activity planners can register their businesses and/or activities with the mood-based search engine and dynamically adjust ambience settings in anticipation of expected changes in activity (or venue) ambiance.

The tables below shows three activities having different “ambience mixes:”

| Activity A | % | Activity B | % | Activity C | % |
|---|---|---|---|---|---|
| Sunny | 50 | Sunny | 20 | Sunny | 50 |
| Sensual | 0 | Sensual | 0 | Sensual | 30 |
| Mellow | 0 | Mellow | 0 | Mellow | 20 |
| Melancholy | 0 | Melancholy | 0 | Melancholy | 0 |
| Energetic | 20 | Energetic | 50 | Energetic | 0 |
| Intense | 0 | Intense | 0 | Intense | 0 |
| Quirky | 30 | Quirky | 30 | Quirky | 0 |

Users searching for Sunny & Energetic activities would see activities A & B listed in accordance with the current embodiment. Users searching for Sunny activities would see activities A & B & C listed. Users searching for Sunny & Energetic activities would likely see activities A & B listed. Users searching for Mellow & Sunny activities would see Activity C. Users searching for Sensual & Mellow activities would see Activity C. However, the results can be tailored further depending on the user's proximity to the above activities as well as the pre-calculated ‘importance’ of the activities. In some embodiments, the search engine can determine ‘importance’ based on mood relevance, whether the activity has existed before, and/or how long the activity has been in the search database.

It should be noted that the search engine might automatically calculate mood mixes of activities and/or entertainment options ranging from live-entertainment to other forms of entertainment (books, movie rentals, video games etc.) While an activity database may be seeded using this process, users may also provide feedback as to their perception of activity ambiences, and such feedback may influence an activity's mood mix. This may not only keep activity ambiences “fresh” in the system but may also enable an understanding of how an activity's ambiences will change during the day and during the week.

In addition, whereas existing searches may depend on complex algorithms to deduce a user's emotions, the disclosed systems and methods can have the user approximate what they are feeling or “in the mood for.” Thus, a timely understanding of how mood influences search (and purchase) behavior by hour and by day may be developed. It is believed that self-indicated mood information can generally be more accurate than inferring a user's mood based on search history, social network posts, and other areas in which a user may express how they feel. For one thing, it has been found that prior moods tend to predict future moods poorly. Such past expressions are often exaggerated/inaccurate because the user is publishing to a social networking audience. Furthermore, users will probably have a vested interest in obtaining meaningful search results. As a result, they will likely be more prone to accurately describe their moods to search engines of the current embodiment than in such social postings.

The disclosed mood-based search engines can therefore make it easier for users to find activities in real-time that are relevant to them geographically, emotionally and contextually. Users can be provided with the ability to search for entertainment opportunities and/or other activities based on time, location, mood, etc. With those variables, options that are of increased pertinence to the user can be returned. By enabling local and/or other businesses and brands to connect with users in accordance with such variables, expanded offerings may be provided to the user and brands and businesses can timely engage with users on an emotionally relevant level. In addition, users can be provided the ability to instantly (or otherwise) find activities on their mobile devices based on their mood history by hour and by day. When collected in a repository for user history, such information can be mined to predict what the user is in the mood to do at a particular time, even before the user realizes it thereby bypassing the need for an initial search. It is possible that such predictive mood-based search will become integral to the user's activity-related planning. Because of the predictive nature of where, why, and how much a user is likely to consume products and services, (local) businesses will have an inherent interest in engaging these search engines. Accordingly, fees can be charged to these 3rd parties to connect with users before, during and after the users' search requests.

When a user searches for information (regarding live music, movies, theatre shows, bars, restaurants, outdoor activities, and/or other activities) based on mood, information for purchasable activities (such as dining reservations, movie tickets, live music tickets, theatre and/or tickets) can be returned. Other related revenue-generating opportunities can also be returned. Third party sponsored advertisements can also be displayed along with the search results. From the user's perspective, as long as the displayed data is contextually, geographically, and emotionally relevant, advertisements would likely be viewed as pertinent, not intrusive advertisements that interrupt the user's train of thought/experience. At this juncture it might be helpful to consider some systems, methods, etc. of various embodiments.

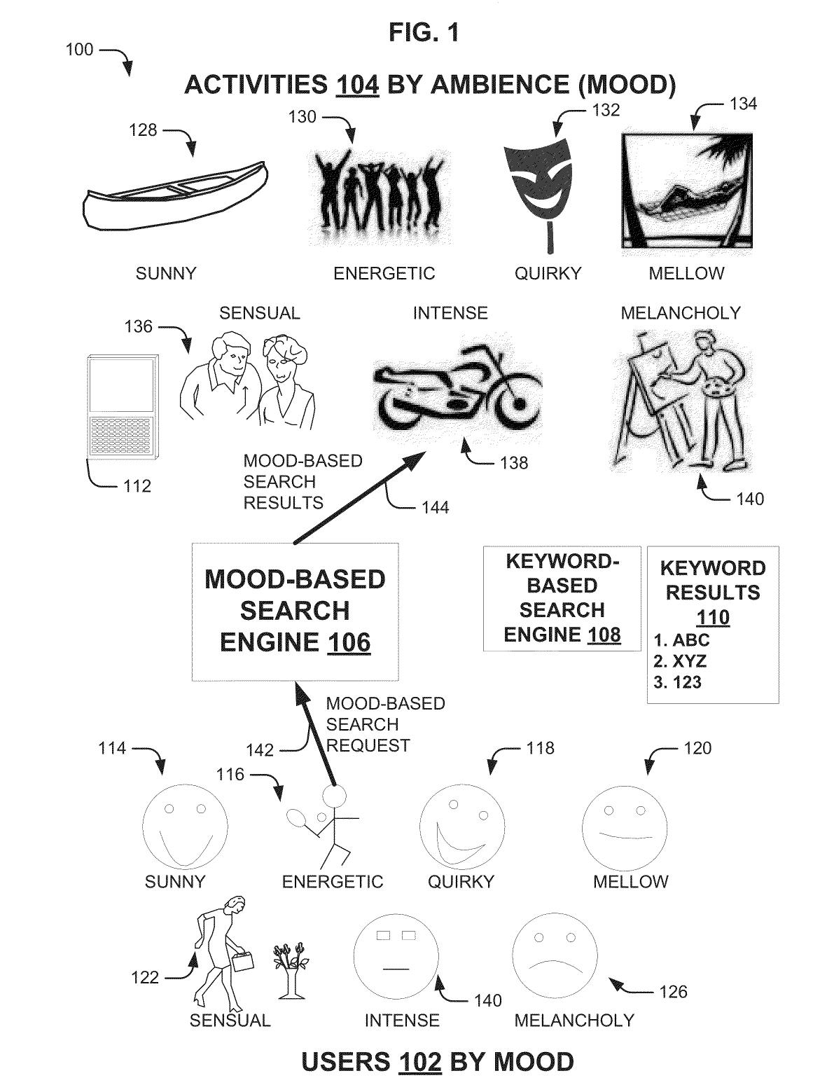

FIG. 1 illustrates an overview of a system for mood-based searching and/or advertising. More specifically, FIG. 1 illustrates a system 100, users 102 in various moods (shown schematically), various activities 104, a mood-based search engine 106, a keyword-based search engine 108, certain keyword-based results 110, and a mobile device 112. The moods include a sunny user 114, an energetic user 116, a quirky user 118, a mellow user 120, a sensual user 122, an intense user 124, and a melancholy user 126. Meanwhile, the activities 104 include sunny activities 128, energetic activities 130, quirky activities 132, mellow activities 134, sensual activities 136, intense activities 138, and melancholy activities 140. FIG. 1 also illustrates a mood-based search request 142 and its results 144.

Often times, a user 102 or group of users 102 will want to find some activity 104 in which to participate. But, they do not know specifically what they want to do. Nor do they even necessarily, have a general idea of what that activity 104 might be. Indeed, all that they might know is that they are in a particular mood “to do something” or in a particular mood “for something.” Accordingly, the user 102 might turn to the Internet to search for a desirable activity 104. With systems previously available the user 102 would use a keyword-based search engine 108 to hopefully find that activity by entering keywords descriptive of the type of activity in which they think they might be interested. But, such approaches stand a high chance of failure when the user 102 has at best only a rough idea of what activity might interest them and/or is unable to articulate it well enough to select proper keywords for the search. Thus, keyword-based search engines rarely return meaningful results 110 in these circumstances. For instance, the Inventor conducted a test of a typical keyword-based search engine 108 using the keywords “Mellow” and “Bar” in an attempt to find a mellow bar. The keyword-based search engine returned a hit for “Mellow Mushroom,” an out of date hit for a restaurant described as being mellow, and a few irrelevant hits. A visit to the purportedly mellow bar revealed it to be the polar opposite of mellow.

In contrast, systems 100 of the current embodiment allow users 102 to perform mood-based searches. More specifically, system 100 allows users 102 to enter self-indicated moods (instead of or in addition to keywords) and the mood-based search engine 106 returns results related to activities defined and/or characterized by their ambience (or subjective mood). The system 100 operates using a predetermined set of moods (and a corresponding predetermined set of ambiences for the activities) which, for some embodiments, includes sunny, energetic, quirky, mellow, sensual, intense, and melancholy. The mood-based search engine 106 accepts inputs from the various users 102 designating whether they are a sunny user 114, an energetic user 116, a quirky user 118, a mellow user 120, a sensual user 122, an intense user 124, a melancholy user 126, or some combination thereof. Meanwhile, the mood-based search engine 106 classifies, identifies, or marks (hereinafter “marks”) each of the various activities 104 as being sunny activities 128, energetic activities 130, quirky activities 132, mellow activities 134, sensual activities 136, intense activities 138, melancholy activities 140, or a combination of those types of activities 104. Thus, when the mood-based search engine 106 receives a mood-based search request 142 it searches its database for activities with ambiences which match (in whole or in part) the requestor's mood and returns the resulting matches.

Thus, a mood-based search for activities for an energetic user 116 might return results related to dancing, tennis, football, jogging, hiking, etc. Likewise, a mood-based search for a sensual user 122 might return results related to chocolate shops, florist shops, fine dining establishments, etc.

Moreover, as is further disclosed herein, the mood-based search engine 106 can include various functions to enhance its results. For instance, the mood-based search engine 106 can include (or work in conjunction with) mapping and geolocation engines to narrow its results to geographic areas of interest to the requesting user 102. Furthermore, if desired, mood-based search engines 106 can create a route and/or schedule for the user for the various (selected) activities in the results. Marketing and/or advertising engines can also enhance the results of the mood-based searches by identifying advertising content that relate to the mood of the requestor and pushing that advertising content to them at times/places at which it might be of particular interest. Additionally, or in the alternative, mood-based search engines 106 of embodiments can work in conjunction with geolocation engines resident on the users' mobile devices 112 to locate them and track their progress with respect to the activities found by their mood-based searches. Moreover, the system 100 can use their mobile devices (or other devices for that matter) to communicate with the user and to request and receive feedback regarding the activities 104 in which they might have participated.

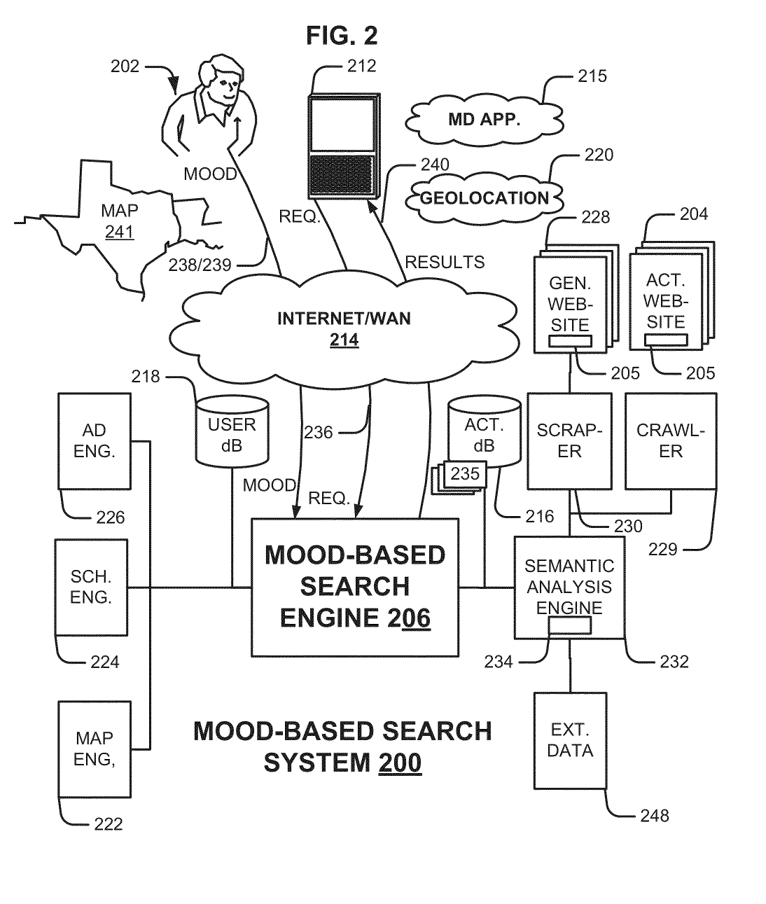

FIG. 2 illustrates a block diagram of a system for mood-based searching and/or advertising. More specifically, FIG. 2 illustrates a system 200, a user 202, an activity website 204, activity-related content (activity content) 205, a search engine 206, a mobile device 212, the Internet 214 (or some other telecommunications network), a mobile application 215, an activity database 216, a user database 218, a geolocation engine 220, a mapping engine 222, a scheduling engine 224, an advertising engine 226, various general websites 228, a web crawler 229, a web scraping engine 230, a semantic analysis engine 232, various variables 234 (of the semantic analysis engine 232), an activity ambience 235 a search request 236, a mood 238, a mood recipe 239, and a result 240. Having listed some components of system 200 it might now be helpful to disclose various aspects of those components.

One such aspect underlying system 200 of the current embodiment is a corpus (or set) of predetermined moods 238. As those skilled in the art understand, moods describe subjective states of mind or emotion or (perhaps) an inclination or disposition. Accordingly, moods can present analytical challenges. Moods vary overtime. They overlap. They possess ill-defined boundaries (even for a given individual). Many words can be used to describe or label some moods whereas one word can implicate many different moods. Indeed, by one count, over 380 individual words exist which in some way label various moods. Thus, it is believed that systems which have attempted to account for such ill-defined user moods have tended to produce poor results. Poor, here, being a measure of how pertinent the users find the results, how complete those results happen to be, how misleading or inaccurate they are, etc.

Moreover, some users have difficulty expressing how they feel. Many “type A” males for instance dislike even considering such topics. It is also possible that some users might make up words to describe their moods. For instance, a user that feels predominately quirky and somewhat mellow might describe their mood as qellow. Such a description might be ignored or entirely missed by many analysis techniques. Thus, asking users 202 to describe their mood tends to produce hard-to-use descriptions at best and, often, unusable masses of emotion-bearing but confused information. Instead, the Inventor has found that allowing the users 202 to pick from a defined set of moods 238 produces results which can be analyzed.

Thus, systems 200 of embodiments use a limited set of predetermined words to characterize the mood 238 (or moods) of the various users 202. In developing a working prototype of a system 200 the Inventor clustered hundreds of mood-related words and identified eight particular clusters of mood words. Each mood cluster was evaluated and chosen so that each was mutually exclusive with the other mood clusters. In accordance with the current embodiment, these word clusters each represent discreet, non-overlapping, mutually exclusive, and subjective moods 238 experienced by humans. While the words selected to identify these mood clusters are non-limiting, the words selected for use with the current embodiment to label user moods 238 are:
Sunny,
Energetic,
Quirky,
Mellow,
Sensual,
Anger/Hatred,
Melancholy, and
Intense.

Moreover, the system 200 incorporates features which reflect the fact that most users 202 concurrently experience more than one of these discreet moods 238 much of the time. For instance, a particular user 202 might be feeling sunny, quirky, and energetic to varying degrees. Then at another time, that same user 202 might feel quirky, mellow, and sensual. Furthermore, while a user 202 might have one combination of moods 238 at one time, they might wish to experience a different set of moods 238 at some future time. Accordingly, for the sake of convenience, the term “mood” 238 herein encompasses a combination of singular moods 238 (each to a potentially differing degree) unless its context clearly indicates a singular mood 238.

Furthermore, systems 200 of embodiments allow users to define mood recipes 239. A mood recipe 239 is a pre-selected combination of singular moods 238 each having some potentially differing degree. Mood recipes 239 can be selected such that they are mutually exclusive and can then be presented to the users 202 for selection of one such mood recipe 239.

In addition, or in the alternative, systems of some embodiments allow users 202 to define their own mood recipes 239. These systems 200 can also allow the user 202 to select a name for each mood recipe 239. For instance, a user 202 could define a mood recipe 239 for a “girls' night out,” name it accordingly, and select (for its particular mixture) a combination of intense, energetic, and quirky singular moods 238. Thus, were the moods 238 be used to define an n-dimensional system, a particular mood recipe 239 would appear as the volume in one of the n-sided corners of that n-dimensional system.

Activity-related ambiences 235 (or ambiences) parallel moods 238 in many ways. For instance, while it is possible that a particular activity might have or be dominated by a singular ambience 235, it is also possible that an ambience 235 might be defined by a combination of singular ambiences 235. Indeed, ambience recipes could be defined and associated with particular activities if desired. Moreover, it might be worth noting that ambiences 235 share at least some of the traits that make moods analytically difficult to analyze. For instance, the ambience 235 of a particular restaurant might shift from predominately mellow during a quiet lunch period while that same restaurant might enjoy an energetic and intense ambience 235 during a busy evening meal. Moreover, it might shift farther depending on the season, weather, and/or other environmental variables.

As to the activities 104 (see FIG. 1) themselves, they can include almost any sort of activity in which users 202 might participate. They therefore include activities related to sports, dining, music, dancing, theater, movies, concerts, sightseeing, touring, learning, etc. Moreover, many venues share traits with activities in the way that going to a restaurant can qualify as an activity. Content related to many activities is available via the Internet (and other telecommunication networks) and the general websites 228 and specific websites (such as activity websites 204) available thereon. For instance, many Internet service providers (ISPs) offer their subscribers (and even others) a landing page with hyperlinks to numerous activity-related websites.

General websites 228 also often provide information and hyperlinks to venues, artists, etc. involved in given activities 104. Of course, one activity 104 might be considered a collection of activities 104. For instance, going to an amphitheater can be an activity 104. Seeing a particular artist or experiencing a particular genre of entertainment at that amphitheater can also be considered a concurrent activity 104. Furthermore, more specific activities 104 often have associated therewith their own websites or activity websites 204. Specific artist that might play at and be advertised in conjunction with a particular venue, (by way of illustration) often have their own activity websites 204. Venues, likewise, often have their own activity websites 204 aside and apart from the website of the artists that perform there. All of these websites, and others, can be considered as activity websites 204 with corresponding activities 104.

Even so, each website related to a particular activity or activities 104 usually makes such content related to the activity (activity content 205) available to the public. Each piece of such activity content 205 can therefore relate to the activity 104 corresponding to the website. Or that activity content 205 can relate to associated activities whether more general, more specific, or in some other way pertinent to the activity 104 of the activity website 204 of interest. Take life bands for instance. An activity website 204 for a particular band often includes information pertinent to that group such as bios of the group members. But, it might also have information pertinent to the venues at which they play and/or the type of music which they play. Moreover, as is apparent, the various websites which provide information about various activities 104 tend to appear, disappear, morph, and otherwise change with time.

System 200 of the current embodiment therefore includes (or makes use of) web crawlers 229 to maintain system awareness of the activity content 205 available to it. These crawlers 229 navigate the Internet verifying the presence of known activity websites 204 and determining whether new websites have appeared since their last crawl. Further, they traverse each website identifying the indexable content therein and reporting their findings back to the system 200. These crawlers 229 can be configured, furthermore, to focus on activity content 205 and/or websites likely to have such content.

Moreover, the crawlers 229 work in conjunction with the web-scraping engine 230 and semantic analysis engine 232 to determine likely ambiences 235 for various activities 104. In some embodiments, the web-scraping engine 230 scrapes some or all of the websites discovered by the crawlers 229 for the activity content 205 which they contain. The semantic analysis engine 232 analyzes the scraped activity content 205 to determine likely ambiences 235 for the activity 104 described by the website. Of course, in so doing, the semantic analysis engine 232 uses a number of variables 234 with which it compares the activity content 205.

The system 200 illustrated by FIG. 2 also includes the activity database 216, the user database 218, and the search engine 206. These components work together to process mood-based search requests 236 and to serve the results 240 to the requestors. For instance, the activity database 216 stores the activity content 205 scraped from various websites and the ambiences 235 as initially marked by the semantic analysis engine 232. Note that the system 200 also provides a user interface (not shown) for administrators to override, update, modify, etc. the ambiences 235 as marked by the semantic analysis engine 232 and/or other data. Moreover, the activity database 216 also accepts and stores feedback from the users 202 regarding the ambiences 235 that they perceived while participating in the various activities 104. With continuing reference to FIG. 2, the user database 218 stores information regarding the various users 202, their search requests 236, the results 240 thereof, their self-indicated moods 238, the activities 104 that they might have selected and/or in which they might have participated, their schedules and trips, their demographic data, their account related information, etc.

The mood-based search engine 206 of the current embodiment receives mood-based search requests 236 from the users 202 and processes them. More specifically, it receives the requests 236 and extracts the moods 238 from these requests 236. Of course those moods 238 can arrive in the form of a mood recipe 239 depending on circumstances. In which case, the search engine 206 can interpret the mood recipe 239 and thereby identify the combination of singular moods 238 contained therein. The search engine 206 of the current embodiment also searches the activity database 216 for activities 104 with ambiences 235 matching or approximating the mood(s) 238 of the requesting user 202. In some cases, the search engine 206 supplements, refines, improves, etc. the results which it finds by comparing it against the user data stored in the user database 218. The search engine 206 of embodiments can also coordinate with other engines, applications, modules, etc. to expand the services it offers to the users 202.

For instance, search engines 206 of embodiments pass the results 240 of these searches to the mapping engine 222. The mapping engine 222 processes the results 240 and generates a map 241 of the activity/venue for the user 202. Note that the mapping engine 222 can work in conjunction with the geolocation engine 220 (resident on the users mobile device 212) to account for the users current location in its processing. Moreover, the mapping engine 222 can limit the results 240 to be passed to the user 202 to those within some selected distance from the user's 202 current location, residence, business, or some other specified location. The resulting map 241 can be passed to the user 202 via the search engine 206 along with the results 240 of the search.

The scheduling engine 224 can also participate in processing the results 240 of the search. For instance, the scheduling engine 224 can also receive the results 240 (either from the search engine 206 or the mapping engine 222) and can develop a schedule/itinerary for the user 202 to follow in traveling to and/or participating in the various activities 104 in the results 240. That schedule can be built interactively with the user 202 selecting activities from among those in the results 240 and otherwise providing feedback to the search engine 206.

Moreover, the search engine 206 of embodiments can also interact with the advertising engine 226. More specifically, as the user 202 navigates between activities 104 (or otherwise moves about), the advertising engine 226 can select advertisements for products, services, activities, etc. that might match the mood 238 of the user 202. Moreover, working in conjunction with the mapping engine 222 and the geolocation engine 220, the advertising engine 222 can push these advertisements to the users 202 as the user is approaching the area in which the advertised activities 104, products, services, etc. are located. Thus, the user 202 might receive timely advertisements which match their mood and would therefore be of likely interest to them.

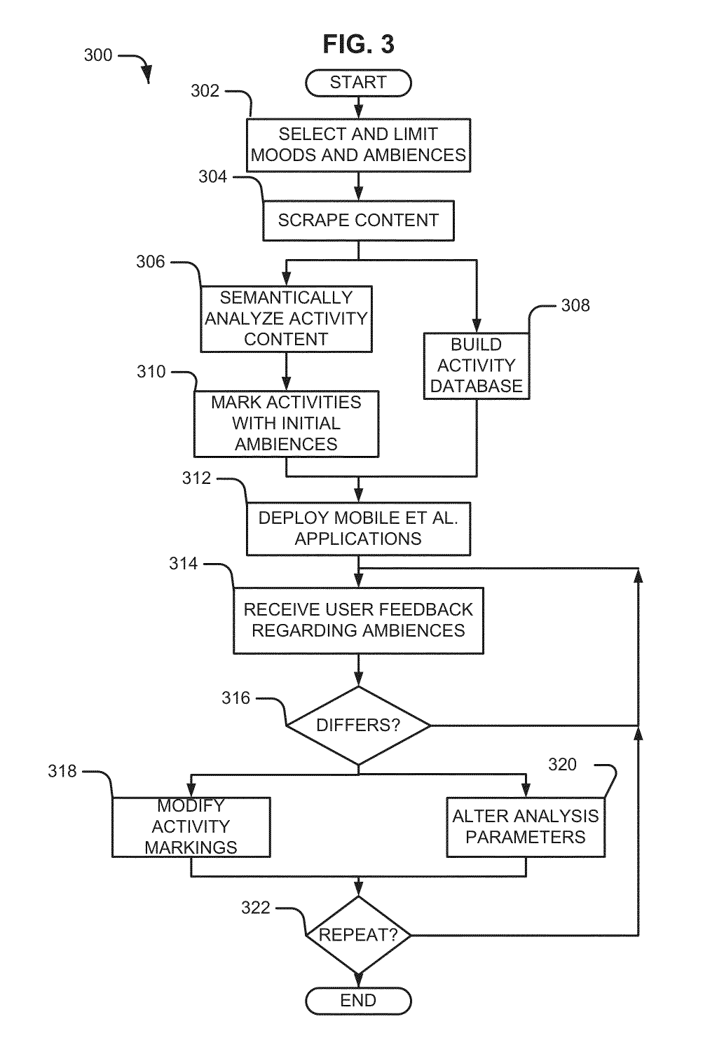

FIG. 3 illustrates a flowchart of a method associated with mood based searching and/or advertising. More specifically, FIG. 3 illustrates method 300 which can be used to initially mark activities 104 with ambiences 235 and/or to maintain the marked ambiences 235 in the activity database 216. In accordance with embodiments, method 300 can begin with an administrator or other user limiting the selection of moods 238 from which users 202 can choose. In many embodiments, this activity can be accomplished by configuring graphical user interfaces (GUIs) for use with the search engine 206 and in the mobile devices 112 to only present the moods 238 which the administrator pre-selects. In one corpus of moods 238 developed by the Inventor, the selected emotions include sunny, energetic, quirky, mellow, sensual, melancholy, and intense. Note that note only is this list of pre-determined emotions mutually exclusive but that it omits a mood cluster as disclosed further elsewhere herein. Thus, if desired, the administrator can tailor system 200 and/or method 300 to process moods 238, ambiences 235, activity content 205, etc. as they relate to only certain types of emotions. In other words, the administrator of system 200 can foster the type of experience that the users 202 will have on system 200 to, for instance, the more positive moods 238. Note that the set of ambiences 235 available for processing reflects the set of limited, subjective, and discrete moods 238 available from which the users 202 can choose in picking their moods 238. See reference 302.

At some point, method 300 can provide for scraping activity content 205 from various websites as indicated at reference 304. For instance, content could be scraped prior to system 200 launch. In this way, the activity database 216 can be pre-populated with activity content 205 for the users 202 and/or for the semantic analysis engine 232. Of course, activity content 205 can be scraped during ongoing operations and/or at other times to keep the activity database 216 current with various activities 104 (or at least the activity websites 204 and/or general websites 228).

Furthermore, method 300 also provides for analyzing the scraped content as indicated at reference 306. Indeed, with the scraped content available, the semantic analysis engine 232 can analyze that content to determine the initial ambiences 235 for the activities 104. In some embodiments, the semantic analysis engine 232 parses the activity content 205 for each activity website 204 (and/or other sources) considering certain mood related words and phrases. From the activity content 205, therefore, the semantic analysis engine 232 derives an initial ambience 235 which it uses to mark the activity 104 in the activity database 216. In accordance with some embodiments, an underlying semantic analysis algorithm resembles some forms of regression analysis. Generally, these algorithms identify whether certain ambience-indicative variables are present in the activity content 205 pertinent to a given activity 104. If so it infers that a corresponding mood 238 (or mood mix) might be associated with the activity 104. The variables include a number of items such as: the manner in which an activity website 204 describes the activity; the manner in which others and/or other websites describe it; activity content 205 on blogs, social networks, etc.; the genre of the activity; the venue for the activity; attributes of the venue (for instance, required/allowed attire, lighting, outdoors/indoors, cuisine, etc.); among other variables.

In some embodiments, the algorithms also consider environmental data 248 (whether related to the physical environment or the social environment) to determine the ambiences 235 associated with an activity. For instance, a source of weather-related data could be queried to determine the weather at (or forecast for) a particular activity. The ambience 235 analyses could be adjusted accordingly. For instance, rainy weather tends to increase the melancholy and/or romantic aspects of many activities. Accordingly, if rain is present at an activity those ambiences (melancholy and sensual) could be accentuated and others deemphasized. The Accuweather website, publicly available online sources, and local newspaper websites represent, respectively, a source of physical environmental data and societal environmental data.

Moreover, the algorithms can apply weights to the various variables 234 to perhaps more accurately predict which ambiences 235 might be involved. The algorithms can sum the weighted scores for each variable associated with each of the ambiences 235 to arrive at scores for each ambience 235. In addition, if desired, the algorithms can apply a multiplier to those ambiences 235 which, over time, appear to be likely to become the predominate ambience(s) 235 associated with the activity 104. Usually, the algorithms converge on a stable mixture of ambiences 235 which is then used to mark the activity 104 in the activity database 216.

In addition, or in the alternative, the semantic analysis engine 232 can analyze activities 104 to determine the extent to which they might match a mood recipe 239. Recall that mood recipes can be pictured as volumes within an n-dimensional space and often volumes in or near the n-dimensional corners of that space. The sides of the corner correspond to the predominate moods of the mood recipe 239 in this model. If the predominate ambiences 235 found for a given activity correspond to the predominate moods 238 in the mood recipe 239 then the semantic analysis engine 232 can deduce that the ambience mix of the activity 104 matches the mood recipe 239. However, if some ambience 235 is associated with the activity 104 that is anti-thetical with any of the moods 238 of the mood recipe 239 then the semantic analysis engine 232 can deduce that the activity would not be a match for that mood recipe 239.

Of course the underlying algorithms could use various analysis techniques. For instance, fuzzy logic and/or artificial intelligence could be employed although they need not be used. Natural language processing can be used as well as common sense analysis of the various variables (for instance, the presence of expensive artwork as a variable would increase the likelihood of a mellow ambience 235).

With continuing reference to FIG. 3, the Inventor obtained feedback on various versions of the underlying algorithms to validate one system 200. Prior to introducing the variable weightings, the ambience 235 predictions of a version of one algorithm matched the predominate ambiences 235 of various activities between about 50% and about 60% of the time. With the weightings applied, another version of one of the algorithms achieved about 75% to about 85% success in predicting the perceived predominate ambiences 235 of the same activities. Further, because the algorithms and its variables can adapt to user feedback, it is anticipated that systems 200 of embodiments can achieve much higher success rates.

The semantic analysis engine 232 also stores pertinent ambience-related activity content 205 in the activity database 216. Thus, when the system 200 presents its results 240 to the users 202, it can also present some or all of the activity content 205 on which it based its initial markings. The system 200 also allows administrative users to alter/override the initial markings for those activities 104 of which they have personal or firsthand knowledge. See reference 308. Thus, as shown at reference 310, the web scraping engine 230 and semantic analysis engine 232 build (and/or maintain, modify, etc.) the activity database 216.

At some point, applications for the users' 202 mobile devices 212 can be deployed. Of course, the devices that the users 202 have need not be mobile. For instance, they could be desktop computers. But, in many situations the convenience of various mobile devices such as smart phones, laptop computers, tablets, notebook computers, etc. lends itself to mood-based searching for activities 104 and/or users 202 that might be in many different locations. Automobile based GPS units (and other devices that are frequently placed in automobiles) represent a potentially useful type of mobile device 212 on to which the user 202 application can be installed. Additionally, the use of mobile devices 212 allows the users 202 to update their search results 240 on the go. Of course, a website associated with the search engine 206 can provide a source from which users 202 can download the mobile device applications. See reference 312.

Furthermore, as the users 202 participate in their activities 104, the system 200 can detect their arrival at, presence at, and departure from the activity 104 via the geolocation engine 220. In some situations the system 200 will await a predetermined amount of time after a user 202 arrives at an activity before querying them for their opinion regarding that activity 104. At that time, for instance 30 minutes after arrival, the user 202 will hopefully have had time to begin experiencing the activity and might be favorably disposed to providing feedback to the system 200. Thus, the system 200 can send a query to the user 202 asking for their evaluation of the ambience 235 of the activity 104. If/when they respond, the system 200 can accept that feedback at reference 314.

Upon receipt of the user feedback (or at some other time), the semantic analysis engine 232 can compare the mood feedback from the user 202 to the existing mark in the activity database 216. If it differs, as determined at reference 316, the semantic analysis engine 232 can simply record the new ambience 235 in the activity database 216 or it can modify the ambience 235 already in the database for that activity. Of course, the semantic analysis engine 232 can wait until some predetermined number of evaluations are fed back to it before altering the ambience 235 recorded in the activity database 216. See reference 318.

In addition, or in the alternative, if the ambiences 235 fed back differ from the initial marking, the semantic analysis engine 232 can use the feedback to alter the variables it used to initially mark that activity 104. In this way, the system 200 can learn from the feedback and therefore keep its analysis current with societal trends. For instance, during the 1960s when the Beatles were quite popular, much of their music was considered to have an energetic ambience 235. But, more than 40 years later, tastes have changed and their music might now be considered mellow. In other words, the underlying algorithm and/or its variables can adapt itself to changes. See reference 320. Of course, if desired, the system 200 can repeat method 300 in whole or in part as indicated at reference 322.

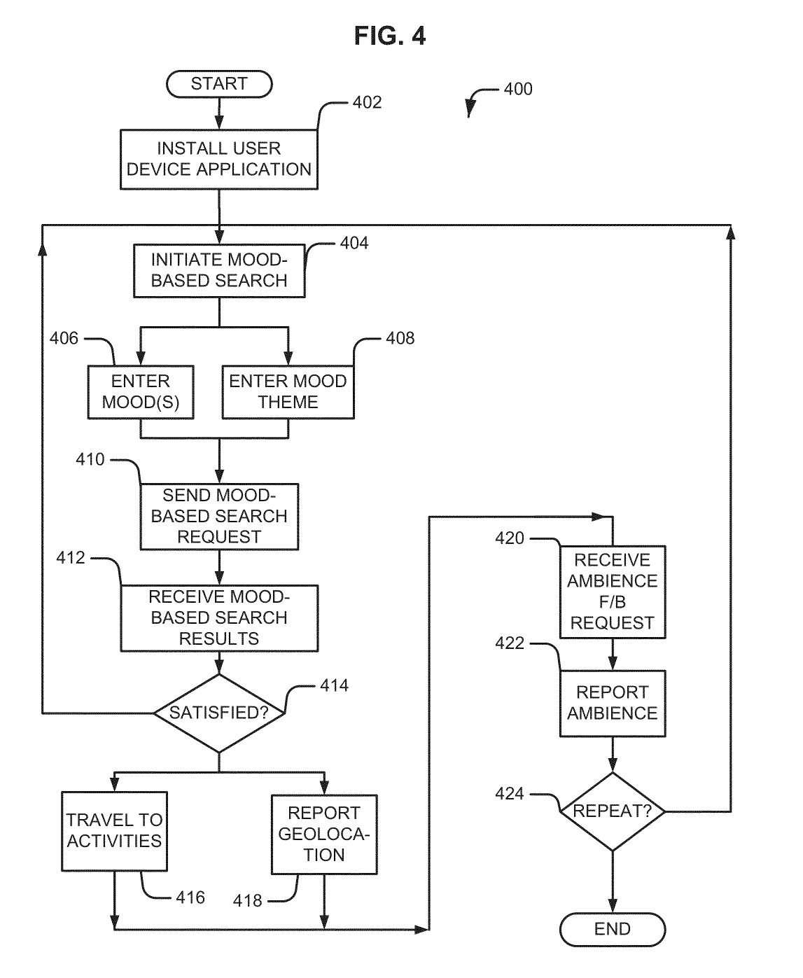

FIG. 4 illustrates another flowchart of a method associated with mood-based searching and/or advertising. More specifically, FIG. 4 illustrates a method 400 via which users 202 can perform mood-based searches and participate in the activities 104 returned in the results 240. At some point, the user 202 can download the mobile device application to their mobile device 212. See reference 402. With the application installed thereon, the user can then initiate a mood-based search including indicating their mood 238. See reference 404 and 406. Of course, the user 202 need not enter their current mood 238. But, instead, the user 202 can enter a mood 238 which they wish to experience. The system 200 can then return results 240 likely to instill that mood 238 in the user 202 (rather than activities 104 that might be conducive to their current mood 238). In the alternative, or in addition, the user 202 can enter a mood recipe 239 instead of their mood 238. See reference 408. Either way, the user 202 can send the mood-based search request to the search engine 206 via their mobile device 212 at reference 410.

After the search engine 206 compares their mood 238 to the ambiences 235 for the various activities 104 in the activity database 216, the search engine 206 of the current embodiment returns the results 240 to the user 202. See reference 412. In some case, even with a mood-based search, the user might not be satisfied with the results, in which case the user 202 can alter their request (and or their mood 238 therein) and repeat the search. But, if the results 240 are acceptable (as will probably happen more often with mood-based searches than without), then the user can proceed with method 400 (see reference 414).

Moreover, the user 202 can inspect the results 240 and select one or more activities 104 in which they are interested in participating. Moreover, since the ambiences 235 of the activities 104 will match the user's mood 238 to some extent, the user 202 is more likely to go to one or more of those activities 104 than they would with keyword-based results. See reference 416. As they go from activity 104 to activity 104 their mobile device 212 can report their location to the system 200 (see reference 418). And, as noted elsewhere herein, the system 200 can send evaluation requests to the user 202 at reference 420. When the user receives the evaluation request they can send the system 200 their evaluation of the ambience 235 of the activity at reference 422. Of course, the user 202 can repeat system 400 in whole or in part as indicated at reference 424.

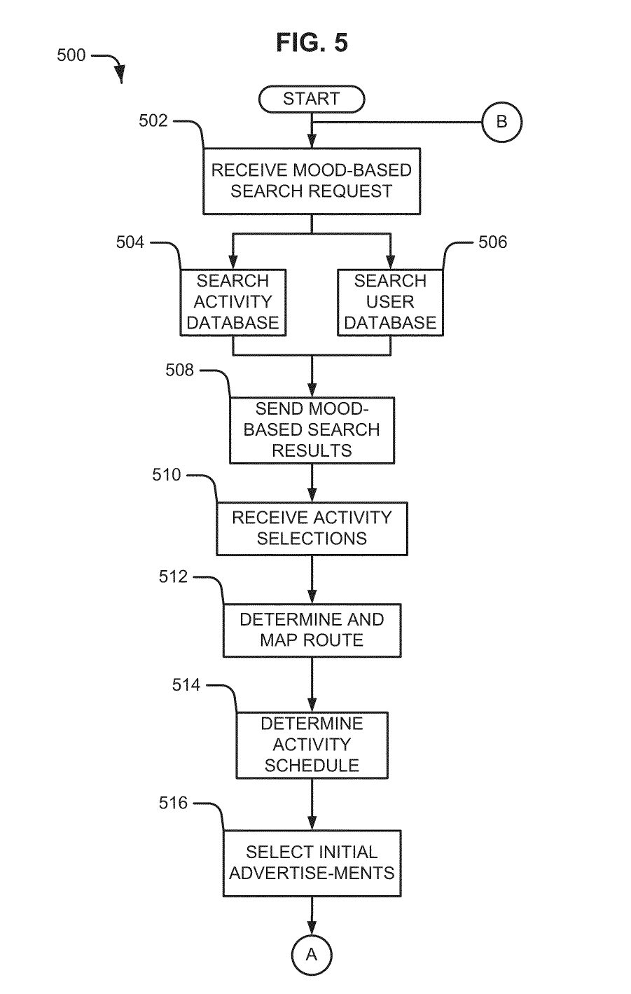

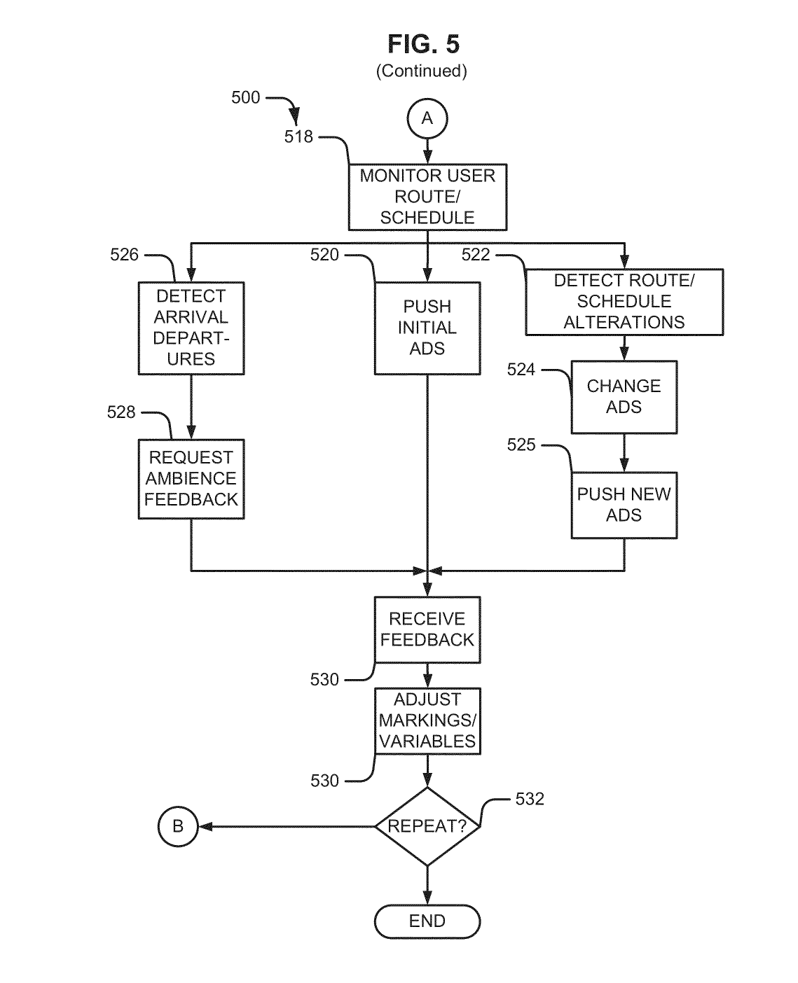

FIG. 5 illustrates yet another flowchart of a method associated with mood-based searching and/or advertising. In accordance with embodiments, method 500 can be used by the system 200 to provide mood-based search services to the users 202. More specifically, method 500 can begin with the system 200 receiving a mood-based search request 236 at reference 502. The search engine 206 can extract the mood 238 of the user 202 from the request 236 and search the activity database 216 for activities 104 with ambiences 235 matching the user's self-indicated mood 238. See reference 504. The search engine 206 can also consider the user's preferences and/or history as indicated by information stored in the user database 218 in ranking the various activities 104. See reference 506. At some point, as indicated by reference 508, the search engine 206 can send the results 240 to the requesting user 202.

Since the results 240 might contain more than one activity 104, the user can select those activities 104 in which they have some interest. The system 200 can receive those selections at reference 510. Of course, the system 200 might instead receive an altered search request 236 from the user 202. At some point, though, the user 202 is likely to select one or more activities and send that information back to the search engine 206. The search engine 206 can coordinate with the mapping engine 222 to determine a route for the user 202 to take between the selected activities 104. See reference 512. Additionally, the search engine 206 can cooperate with the scheduling engine 224 to develop a schedule of the activities 104 for the user 202 at reference 514. The search engine 206 can also coordinate with the advertisement engine 226 to make an initial selection of products, services, activities 104, etc. along (or near) the route which might be of interest to the user 202 (based on their mood 238 inter alia). See reference 516.

As the user 202 progresses through the schedule, the system 200 can monitor their actual route. See reference 518. At various points on the detected route, the system 200 can select advertisements for nearby activities 104, businesses, goods, services, etc. and send those advertisements to the user 202. Of course, the system 200 can time the advertisements so that they are likely to arrive at the users mobile device 212 enough in advance that the user 202 has time to consider the advertisement and to alter their route accordingly. In this way among others, the advertising businesses will receive a well-qualified customer in response to the advertisement. More specifically, since the ambience 235 associated with the advertisements (or underlying activities 104, products, services, etc.) can be selected to match the mood 238 of the user 202, the user 202 is likely to be pre-disposed to add the advertised activity to their itinerary. Furthermore, because of the ambience 235/mood 238 match, the user 202 is likely to find the advertisement useful through real-time pertinence rather than a nuisance. Thus, the user 202 also obtains a benefit from the advertisement. See reference 520.

It might be the case that the user 202 alters their actions from the schedule determined by the mapping and scheduling engines 222 and 224. Because of the location reporting available from the geolocation engine 220 on the user's mobile device 212, the search engine 206 can detect such route/schedule alterations. See reference 522. In such cases, the system 200 can be configured to re-select the advertisements that it plans to send to the user 202 in accordance with the new route. See reference 524. At appropriate times/locations the search engine 206 can push the new (but still pertinent) advertisements to the user 202 at reference 525.

Whether the user 202 adheres to the planned schedule, the system 200 can detect their arrival at, and/or departure from, the various activities 104 as illustrated by reference 526. At pre-selected times relative to these activities 104, the system 200 can send the users evaluation requests (see reference 528). The system 200 can also receive their evaluations of the ambiences 235 of the various user-attended activities 104. See reference 530. With that feedback, the system 200 can then update the ambience 235 stored in the activity database 216 for the pertinent activity 104 and/or update its semantic analysis variables 234 as might be desired. See reference 531. Of course, system 200 can repeat method 500 in whole or in part as indicated at reference 532.

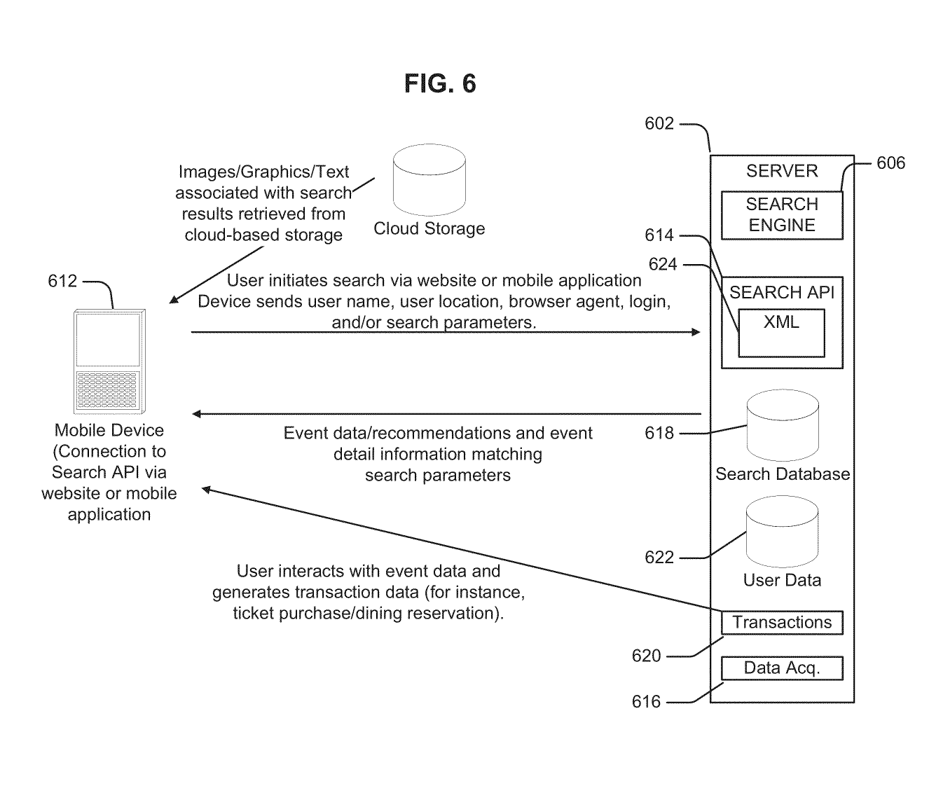

FIG. 6 illustrates an embodiment of a system 600 that supports user-based searches. The system 600 includes a server 602 that hosts a search engine 606 which can communicate with one or more user devices 612. For example, the server 602 may host a website that computing devices (such as laptop computers, desktop computers, etc.) and mobile devices 612 (such as smartphones, tablet devices, GPS units, etc.) may access via the Internet, cellular networks, and/or other telecommunication networks. The server 602 may also communicate with a mobile application installed on a mobile device 612. Communication between the server 602 and user devices may be secured (via encryption and/or other protocols) if desired.

In one implementation, the server 602 may host a search application programming interface (API) 614 that translates data received from user devices into a format compatible with the search engine 606, and vice versa. For instance, the search API 614 may translate data to and from parsed extensible markup language (XML) for server-side processing.

The server 602 may include a data acquisition module 616 that acquires data stored in a search database. A search database 618 may be present at the server 602, as shown in FIG. 6, or it may be located remote to the server 602. The data acquisition module 616 may execute Internet crawlers (such as automated processing threads that visit particular websites to generate content for the search database 618). The data acquisition module 620 may also retrieve data from third party data vendors. For example, data feeds from third party data vendors (movie listing vendors, restaurant reservation vendors, etc.) may be periodically and/or manually parsed to add data to the search database 618. The data acquisition module 616 may also support manual entry of data into the search database 618. Manual data entry may be performed by a search engine administrator and/or by users of the search website if desired.

The server 602 may include a transaction module 620 that executes transactions requested by users. For example, the transaction module 620 may implement ticket purchases, dining reservations, etc. The transactions may be wholly implemented on the server 602 or may be implemented based in part on third-party ticket vendor/restaurant reservation APIs. Data regarding such transactions can be stored in the user database 218 and subsequently used in refining search results for the user 202.

The server may include, store, and/or have access to user data 622. The user data 622 may include user profile information, user preference information, user search history, user transaction history, or any combination thereof. Each user may be associated with an account at the search website of the current embodiment. Account information (such as login information) may also be stored in the user data 622.

During operation, a user 202 may initiate a search operation via the search website or the mobile application. The user's device may receive (via user entry and/or retrieval from device cache for instance) and send to the server search information, such as a user name, a user location (for instance, their location as determined by a global positioning system (GPS) module within the user device and/or networking attributes of the user device), browser agent (for instance, whether the user is using a mobile or full-featured browser to access the search website), login information, search variables, or any combination thereof. Search variables may include an identification of an activity (for instance, movie), one or more moods (for instance, quirky), a desired geographic area (for instance, within 3 miles), demographic information (for instance, movies that will most likely be watched by men or women over 30 years of age), genre (for instance, comedy), and/or price (for instance, less than or equal to $10). One or more of the search variables may be populated based on a predetermined mood recipe selected by the user (such as “sunny day of bliss,” “romantic date night,” “hot sweaty dance night,” “girls night out,” etc.). Mood recipes may be defined by the search engine owner and/or by the user in the user data. In one implementation, mood recipes may indicate a mood mix that allocates percentages (summing to 100%) to one or more of seven pre-defined moods: mellow, melancholy, quirky, sunny, energetic, intense, and sensual. Each mood may be associated with a color scheme used in displaying search interfaces (GUIs for queries, results, result details, etc.). For example, the aforementioned moods may be associated with dark blue, lime green, turquoise, yellow, red, orange, and purple, respectively.

Additionally, mood recipe (pre-defined by the search engine company, the advertiser, or the user) based-searches may be themed by color and graphics. Whereas “Sunny Day of Bliss” may exhibit imagery and styling representative of a “beach-like” or “swimming in the lake” feel or mood mix, a theme like “Romantic Date Night” may use imagery and styling conventions representative of romance—candles, chocolate, hearts, floral imagery, etc. The use of imagery may help frame the activity content in such a way that the user is more easily able to connect with the activities, regardless of the spread of genres related to the activities. Brands and (local) businesses with similar themes may thus be provided with the ability to co-brand (blend their branding with company graphics and design schemes) themed mood-recipes in exchange for a fee (charged via the transaction module if desired) commensurate with the level of geographic, demographic, and emotional relevance they choose.

Upon receiving data indicating a search, an XML translation module 624 of the search API 614 may translate the data into parsed XML and provide the parsed XML to the search engine 606. The search engine 606 may query the search database 618 based on the parsed XML and generate search results. Before, during, or after the search, information associated with the search may be stored in the user data 622. For instance, the search variables and/or the date/time of the search may be stored in the user data 622. The search results may be provided to the search API 614, which formats and sends activity data, recommendations, and activity detail information back to the user device 612. Within a fee-based service (implemented via the transaction module if desired), third party advertisements may also be included in the search results. The advertisements may have been pre-stored at the server 602 and/or generated by third parties via an advertisement generation API to be included in search results based on specified search variables. For instance, a nightclub may provide an advertisement to be included in search results for “hot sweaty dance night” or “energetic” activities. Besides being included as inline search results, advertisements may be included adjacent to search results (for instance, as banner ads or “in-line” ads).

Upon receiving the search results, the mobile application or browser at the user device 612 may display the search results. Displaying the search results may include displaying graphics and text associated with the search results. Such graphics and textual descriptions may be retrieved from cloud-based storage (for instance, involving XML/JSON information), as shown. The user may interact with the search results to generate a transaction (for instance, a ticket purchase or a dining reservation). Data regarding the transaction may be transmitted to the transaction module 624, which may complete the transaction. The user data 622 may be updated to reflect the transaction (for instance, to reflect that the user purchased a ticket to a particular activity, made a reservation at a particular restaurant, etc.). If the user is not logged in and doesn't have an account, such information may be cached in a server-side and/or device-side cookie.

As the user selects activities, an itinerary may be formulated and stored in the user data 622. The activities saved to the itinerary may be mapped in order of start date and time. Based on the locations of the activities, a predicted travel path of the user may be determined. The travel path may be provided to the search API, so that path-dependent contextual advertisements may be provided to the user while the user is en-route to the activities. Ads may be added as activity options when the user loads his or her itinerary. Sponsored results may be displayed based on factors such as time, location, user, user purchase/viewing history, etc. upon the user's next interaction with the search engine 606 via the website or the mobile application. Interactions with the path-dependent ads may also be added to the user history in the user data 622.

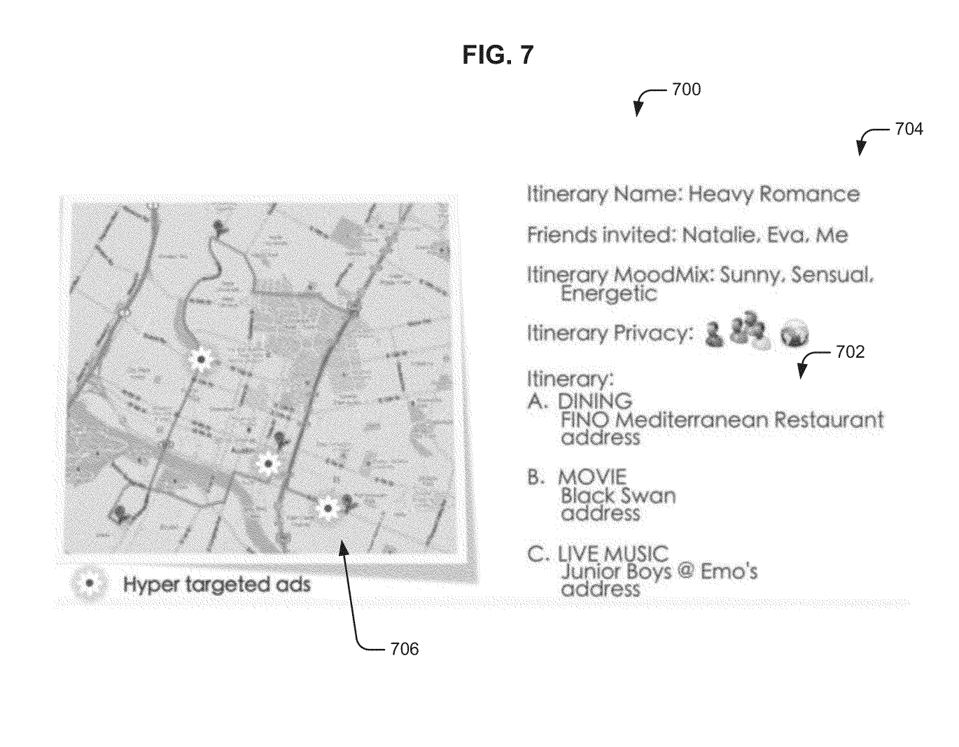

FIG. 7 illustrates path-based GUI for mood-based advertising. In the GUI 700 shown, the user has invited Natalie and Eva to a “heavy romance” itinerary 702 having a sunny/sensual/energetic mood mix 704. The itinerary's privacy setting indicates that the itinerary is to be shared with the user and the user's friends. Such sharing may be implemented via the search engine 606 or search engine mobile application, text messages, social network messages (such as Facebook or Twitter), etc. The illustrative itinerary 702 includes dining at a Mediterranean restaurant, watching a particular movie, and experiencing a particular live music activity. Within this context, the user has told the search engine that, he/she wants to be entertained, he/she wants to be entertained right now (since these activities are time-sensitive), and how much money he/she willing to spend based on the activities (based on the pricing information for the activities). This information may be valuable to an advertiser in creating hyper-targeted advertisements in which both the user's emotional context and locality are considered. As shown in FIG. 7, such hyper-targeted ads 706 may be provided to the user at different places on the user's path and/or regarding other vendors on the user's predicted path. For instance, while the user is en-route from the Mediterranean restaurant to the movie theater, the user may be passing by a florist that has contracted with the search engine provider. The florist may consider itself ideal for people in a romantic frame of mind, and may be provided the opportunity to present a hyper-targeted advertisement to the user. For privacy reasons, the florist may not be provided details regarding the user's identity unless the user interacts with the hyper-targeted advertisement. Nonetheless, because the advertisement reflects the emotional context and locality of the user, the response of the user can be more favorable than would otherwise be the case. Indeed, these advertisements might, to the user, resemble more of a welcome reminder of the advertised activity rather than a portion of an overload of advertised information.

With continuing reference to FIG. 7, path-based processing may enable “replacement” activities to be provided with increased accuracy. For instance, suppose that on the night of the date, the Mediterranean restaurant at the beginning of the itinerary in FIG. 7 may be experiencing a surprise closure. In such a situation, the search engine may automatically provide a list of “replacement” restaurants that are similar in ambience, that have a reservation available, and that are on or near the previously established path. The user may advantageously be able to cancel the reservation at the Mediterranean restaurant, create/purchase a new reservation at the replacement restaurant, and notify subscribers to the itinerary regarding the change in dining destination from a single device (such as a mobile phone) with the device side application of embodiments installed thereon.

When a user searches using a mobile device, this may indicate a higher preference for real-time information when compared to a search conducted using a more “fixed” device, such as a desktop computer. The search engine 606 may use the device type as an additional metric to gauge advertising relevance. In this scenario, a search engine provider can align deals and ads from 3rd party groups that are time-limited to being accepted by some number of hours from the time of the search request. To illustrate, consider the following scenario:
a. The user initiates mood-based search from a mobile device.
b. The search engine 606 records the browser-agent, the device type, user request, user location, and time of search.
c. If the user is logged in, gender and age are also stored.
d. A 3rd party advertiser (via Search API 614) can push deals specific to the combination of the aforementioned user-related and mood-related variables.
e. These deals can be time-sensitive (available for up to a certain number of hours from the time of the search).
f. The deals/ads continue to show alongside/inline with the search results until their time of expiration or until the user removes them from the results listings.

In contrast to the foregoing scenario, when a user searches using a more “fixed” device, this may indicate that the user is at their home or office and not at an activity destination. The search engine 606 may use this information to infer that the user is in the process of “planning what to do.” This information may be used as an additional metric to gauge advertising relevance. In the current embodiment, the search engine 606 can align deals and ads with the user plans for a fee (implemented via the transaction module if desired) from 3rd parties. These deals can be designated as being time-sensitive (acceptance being limited to occurring with some time from when the search request was placed).

As described above, activities may be searched based on a predefined “mood recipe.” For such searches, 3rd party ads may be dynamically populated alongside the activities listed for a mood recipe. For instance, ads specific to the mood recipe “romantic date night” can include information, coupon, deals, etc. relevant to that night (or for sometime in the future) as specified by the 3rd party.

Furthermore, activity itineraries may be created from a combination of mood-based search results. The search engine 606 may provide an itinerary tool to add destinations to an itinerary. The itinerary may include username, user demographic information, location, time of searches, activity names, activity locations, activity times, activity types, ambiences for each activity, aggregate/average of users for itinerary, sharing preferences, etc. The search engine 606 may dynamically insert ads based on 3rd party placement preferences related to the variables listed above among others.

Revenue generating advertisements may also be placed in or alongside search results based on user history. For instance, through the use of cookies and/or cookies from the user login, the search engine 606 can track the theme/history of a user's mood-based searches. Based on this information, the search engine 606 can infer a user's trend in moods and can better predict a user's emotional pattern for daily, weekly, monthly, and seasonal time frames. Based on this information, the search engine 606 can deliver ads upon user entry into the search engine 606 (based on initial navigation to the search website or launching of the mobile application as might be desired) that are based on the user's search history. In other words, the search engine 606 may dynamically populate activities and ads inline/alongside activities as soon as a user enters the search engine 606. The search engine 606 of the current embodiment also includes (based on user email preferences in some embodiments) the ability to serve activity recommendations and ads via e-mail, text message, instant message, social networking message, etc. so that a user need not visit the search engine 606 directly for activity recommendations.

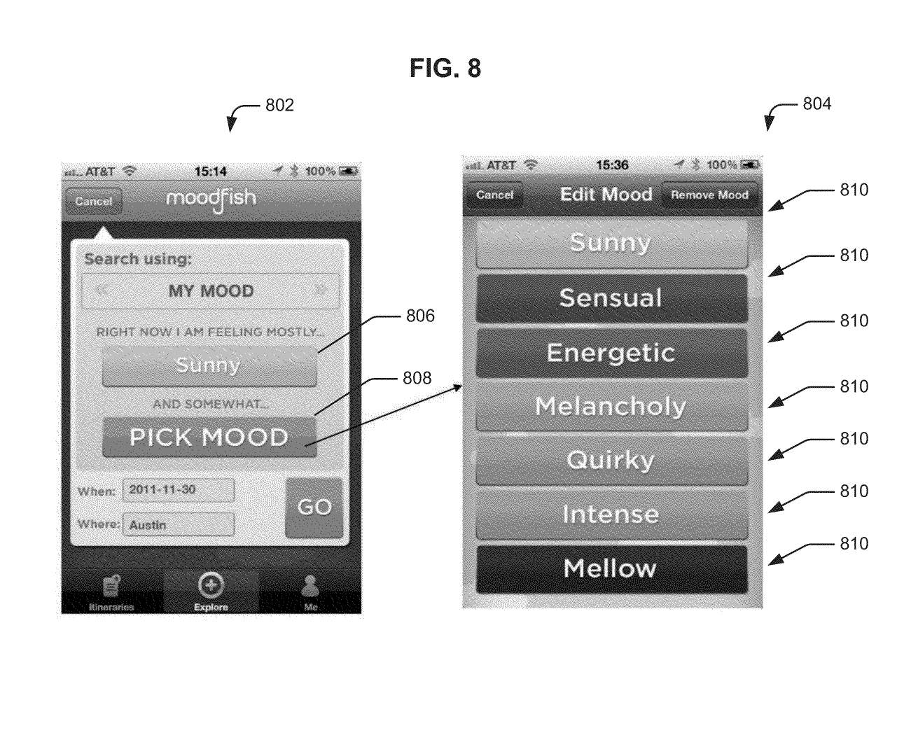

FIGS. 8-11 illustrate various examples of interfaces associated with mood-based searches, search results, itineraries, and social networking. In the embodiments shown, the search is performed via a mobile device 612 (such as a mobile phone). It should be noted however that similar interfaces tailored to other aspect ratios and resolutions may be used when implementing mood-based searches on other devices (tablet, laptop, desktop computers, etc.).

More particularly, FIG. 8 illustrates interfaces 802 and 804 associated with initiating a search based on a primary mood 806, a secondary mood 808, a tertiary mood, a date, and a city. One or more of these criteria may be optional.

With regard to the mood editing GUI 804, it can be resident on a user's mobile (or other) device and can provide a convenient interface for entering/editing a user's mood 238. For instance, each of the mood icons 810 can correspond to one of the moods 238. The GUI 804 can be configured such that the order in which a user taps the mood icons 810 indicates their order of predominance. In addition, the number of times a user taps a given mood icon 810 can indicate the strength with which they feel (or would like to feel) that mood 238.

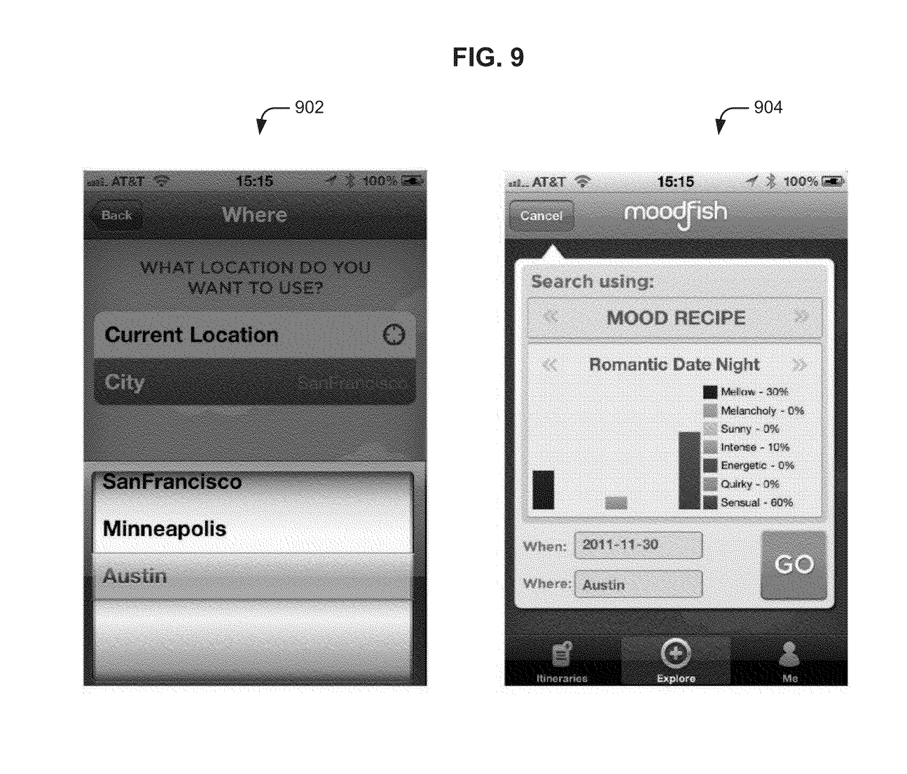

FIG. 9 illustrates interfaces 902 and 904 associated with selecting an available city or using a current location (as determined by a global positioning system (GPS) transceiver of the user's device if desired), and with searching using a pre-determined mood recipe 900.

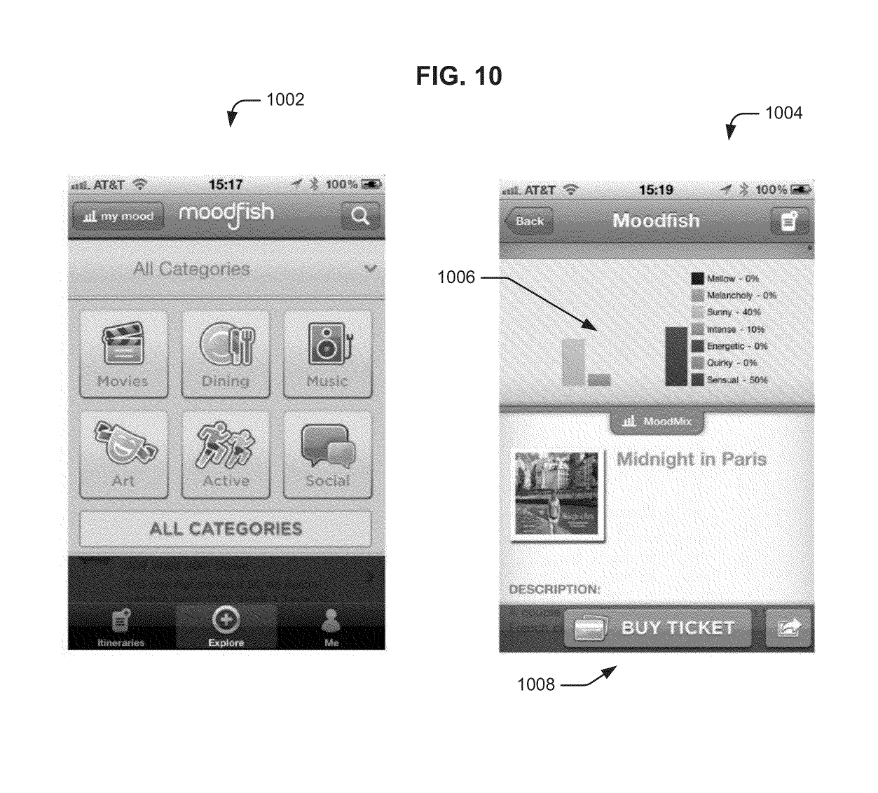

FIG. 10 illustrates interfaces 1002 and 1004 associated with searching for results in particular categories and a “pull down” details page 1006 for a particular search result (such as a movie) that includes an option to buy a ticket 1008. More detailed pages may also include information such as descriptions, user reviews, critic reviews, maps to the venue, menus when the result is a restaurant, and other purchase links. For instance a link to purchase an audio file of a song when the search result is a live music activity, merchandise, etc. can be provided.

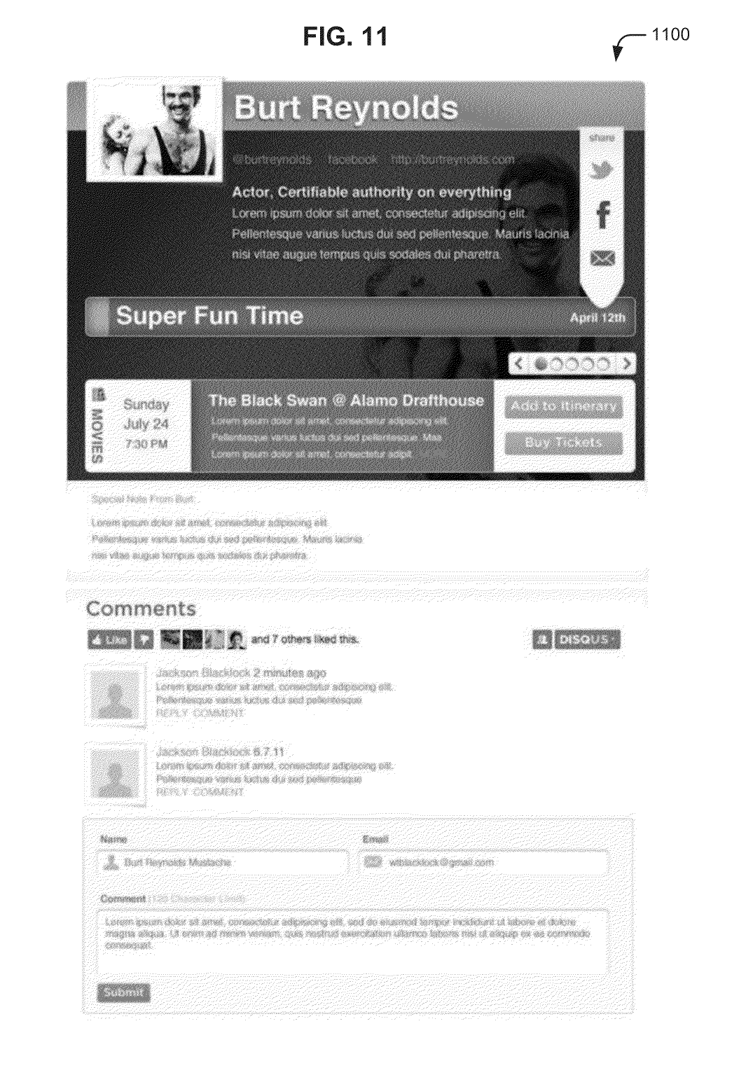

FIG. 11 illustrates an example of a curated activity recommendation itinerary. Such itineraries 1100 may be curated by restaurants, celebrities (such as Burt Reynolds in FIG. 6), etc. More specifically, a brand or local business with an established or well-known ambiance may select activities that are complementary to their venue. To illustrate further, a well-known romantically oriented restaurant may create and share an itinerary 1100 complete with romantic activity recommendations, which may then be sent to the user via e-mail, text message, push notifications to mobile applications, etc. Moreover, these notices can be sent to all fans, subscribers, previous visitors, etc. as determined from stored user history if desired.

Various filters may be applied during mood-based searches. For instance, geo-based filtering (such as limiting the results to those within walking distance, 1 mile, 3 miles, 5+ miles, etc.) may be provided as options when initiating a search. Additional filters such as price-based, genre-based, demographics-based, etc. filters may also be implemented. For instance, in the context of a mobile application, a side swipe to the left or right may trigger display of additional filters on the search interface. A side swipe to the left or right on a pull down details screen may enable a user to provide feedback on the activity. That feedback, by the way, may be shared with other users, may be used to modify ambience ratings for the activity, etc.

It will be appreciated that the various illustrative logical blocks, configurations, modules, and algorithms described in connection with the described embodiments may be implemented as electronic hardware, computer software, or any combinations thereof. Thus, various components, blocks, configurations, modules, and algorithms are described herein in terms of functionality. Whether such functionality is implemented as hardware or software depends upon the particular application and design constraints imposed. Skilled artisans may implement the described functionality in varying ways for each particular application, but such implementation decisions should not be interpreted as causing a departure from the scope of the present disclosure.

The methods and algorithms disclosed in connection with the embodiments disclosed herein may be embodied directly in hardware, in a software module executed by a processor, or in a combination of the two. A software module may reside in random access memory (RAM), flash memory, read-only memory (ROM), hard disk, a removable disk, or any other form of non-transitory storage medium. The storage medium can be coupled to a processor such that the processor can read information from, and write information to, the storage medium. In the alternative, the storage medium may be integral to the processor. The processor and/or storage medium may reside in a computing device (e.g., a laptop computer, a desktop computer, a tablet computer, etc.) or a user terminal (e.g., a mobile phone).

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. A method comprising:
pre-determining a set of subjective, discrete, and non-overlapping moods;
receiving, via a network, a mood based search request which includes an indication of a mood of a requestor, the requestor mood being limited to the predetermined set of moods and wherein the limited requestor mood further comprises multiple moods;
searching a database stored on a computer readable media which is not a signal for activities having an ambience which is subjectively suitable for the limited requestor mood using a processor;
outputting an indication of at least one activity which has an ambience which is subjectively suitable for the limited requestor mood via the network;
targeting advertising to the requestor based on a path between a location associated with the requestor and a location of at least one of the activities; and
limiting the targeted advertising to advertising pertaining to activities having ambiences which are subjectively suitable for the limited requestor mood.

2. A method comprising:
receiving, via a network, a mood based search request which includes an indication of a mood of a requestor, the requestor mood being limited to a predetermined set of discrete moods;
searching a database stored on a computer readable media which is not a signal for activities subjectively suitable for the limited requestor mood using a processor; and
outputting an indication of at least one activity with an associated ambiance which is subjectively suitable for the limited requestor mood via the network.

3. The method of claim 2 further comprising receiving feedback from a user regarding the actual subjective mood of the activity.

4. The method of claim 3 further comprising adjusting the initially marked ambience of the activity responsive to the feedback.

5. The method of claim 3 further comprising adjusting variables from which the initially marked ambience was derived.

6. The method of claim 2 further comprising targeting advertising to the requestor based on a path between a location associated with the requestor and a location of at least one of the activities.

7. The method of claim 6 further comprising limiting the targeted advertising to advertising pertaining to activities with ambiences which are subjectively suitable for the limited requestor mood.

8. The method of claim 2 wherein the limited requestor mood further comprises multiple moods.

9. The method of claim 2 further comprising receiving an indication of a mood recipe, the limited requestor mood being received via the mood recipe.

10. The method of claim 2 further comprising initially marking the activities in the database with ambiences.

11. The method of claim 10 wherein the initially marking the activities further comprises web scraping content regarding the activities and semantically analyzing the scraped content.

12. An apparatus comprising:
a network interface;
a processor; and
a memory storing processor readable instructions which when executed by the processor cause the processor to perform a method comprising:
receiving, via the network interface, a mood based search request which includes an indication of a mood of a requestor, the requestor mood being limited to a predetermined set of discrete moods;
searching a database stored in the memory for activities defined in part by corresponding ambiences which are subjectively suitable for the limited requestor mood using the processor; and
outputting an indication of at least one activity defined in part by an ambience which is subjectively suitable for the limited requestor mood via the network interface.

13. The apparatus of claim 12 wherein the method further comprises receiving feedback from a user regarding the ambience of the activity.

14. The apparatus of claim 13 wherein the method further comprises adjusting the initially marked ambience of the activity responsive to the feedback.

15. The apparatus of claim 13 wherein the method further comprises adjusting variables from which the initially marked ambience was derived responsive to the feedback.

16. The apparatus of claim 12 wherein the method further comprises targeting advertising to the requestor based on a path between a location associated with the requestor and a location of at least one of the activities.

17. The apparatus of claim 16 wherein the method further comprises limiting the targeted advertising to advertising pertaining to activities defined in part by corresponding ambiences which are subjectively suitable for the limited requestor user.

18. The apparatus of claim 12 wherein the method further comprises receiving an indication of a mood recipe, the limited requestor mood being received via the mood recipe.

19. The apparatus of claim 12 wherein the method further comprises initially marking the activities in the database with subjective activity ambiences.

20. The apparatus of claim 19 wherein the initially marking the activities further comprises web scraping content regarding the activities and semantically analyzing the scraped content.
